(19) United States
(12) Patent Application Publication
(10) Pub. No.: US 2011/0012333 A1
(43) Pub. Date: Jan. 20, 2011

(54) System and device for mechanically extending and retracting landing gear of a semitrailer or chassis

(75) Inventor: Adam D. Griffin, Newcastle, OK (US)

Correspondence Address: Juan Carlos A. Marquez;c/o Stites & Harbison PLLC, 1199 North Fairfax Street, Suite 900, Alexandria, VA, 22314-1437, US

(73) Assignee: John L. Quaid Family Limited Partnership

(21) Appl. No.: 12/458,501

(22) Filed: Jul. 14, 2009

(51) Int. Cl. B60S 9/02

(52) U.S. Cl. 280/766.1

(57) ABSTRACT

The herein described system is used for mechanically extending and retracting a semi trailer's/chassis landing gear to support, raise or lower the trailer or chassis. Such system utilizes the existing apparatus minus the manual “crank” currently attached to the shaft which, in turn, is attached to the gear reduction box assembly. The manual crank is replaced with an “adapter” on the outboard shaft. This adapter is then attached as needed to a pneumatic, hydraulic, or electrically powered device to turn the shaft thereby mechanically moving the landing/leveling legs into the desired position. The pneumatic device is powered by a connection inherent to the system attached to the semi trailer or tractor's air brake line. The hydraulic device may be powered by an external hydraulic system. The electrical device may be DC battery powered or attached to an inverter in/or on the tractor.

### BACKGROUND OF THE INVENTION

1. Field of Invention

The system of this invention resides in the arena of semi-trailer/chassis landing gear extension, retraction and leveling mechanisms and more particularly relates to a power assisted mechanical system for the raising and lowering of a semi-trailer/chassis landing gear for positioning and/or raising or lowering the trailer or chassis.

2. Description of Prior Art

Many semi-trailers/chassis have front landing gear for support of the front of the trailer when the tractor is separated. These landing gear are generally two spaced apart, jack-type devices joined by a cross member with a common drive shaft engaged with a gear reduction box assembly. The gear reduction box assembly is driven by a manually operated crank. The gear reduction box assembly can have, and generally does have, two gear operating ratios: a low gear and a high gear. The gear ratio utilized within the gear reduction box depends upon the lateral positioning of the crank shaft. Manually operated jack structures are difficult to use, require significant time for the operator, and expose that operator to potential injuries as he or she is positioned next to the trailer/chassis while turning the crank to raise or lower the landing gear to in turn raise or lower the trailer/chassis.

The prior art includes many devices for the motorized extension and retraction of landing gear apparatuses for semi-trailers. Many of these prior art systems require their installation on the semi-trailer at the time of its construction or at the time of the installation of the landing gear thereon. Typical of such prior art in U.S. Pat. No. 4,466,637 to Nelson which discloses an electric motor to drive the usually manually operated crank system for raising and lowering of the semi-trailer landing gear. The prior art also teaches that when using electric motors, such motors can be controlled from within the cab of the vehicle such as taught in U.S. Pat. No. 4,097,840 to Chappelle. Pneumatically powered actuators for raising and lowering the semi-trailer's landing gear are disclosed in U.S. Pat. Nos. 4,400,986 and 4,402,526, both owned by the Atwood Vacuum Machine Company. These patents disclose a complex structure to receive pressurized air for the actuators to rotate the crank shaft of the gear reduction assembly to raise and lower the landing gear. U.S. Pat. No. 4,345,779 to Busby discloses a pneumatically operated drive unit attached to the shaft of the gear reduction box assembly, which drive unit is disposed to the outboard side of the gear box and utilizes a pneumatic impact motor which is attached to a nut member welded to the end of the gear reduction box assembly drive shaft. These types of units, though, provide a pulsating drive that is not conductive to the desired smooth operation of raising and lowering the landing gear legs. U.S. Pat. No. 3,874,696 to Gardner teaches that a landing gear can be pivoted rearward or forward by an air cylinder receiving air from the air brake line or the emergency air brake line of the trailer. The landing gear of Gardner is not directly adjustable up and down by a gear system and cannot raise or lower the trailer. Other means for the raising and lowering of landing gear are known in the prior art such as the use of hydraulic pistons as disclosed in U.S. Pat. No. 3,503,588 to Bach. The hydraulic system of Bach is large and cumbersome, and hydraulic pistons do not provide the same positive holding as provided by a gearing arrangement. Power failure or loss of pressure could cause failure and collapse of the landing gear.

Because of the complexity and expense of prior art systems for raising and lowering semi-trailer landing gear, they have not been widely accepted in the trucking industry. Also, because of the prior art's complexity and need for specialized parts, many of which have proven to be fragile, they have been generally unsuitable to the rugged demands of over-the-road semi-trailers in use of a daily basis.

### SUMMARY OF THE INVENTION

It is an object of this invention to provide an improved landing gear raising and lowering system using an adapter coupled with the existing gear reduction box assembly and a hydraulically powered, or an electrically powered, or pneumatic motor utilizing air from the vehicle's existing air pressure lines that extend to the brakes of the trailer which system operates in a simpler, smoother and far less complicated fashion to raise and lower the landing gear of a semi-trailer/chassis than prior art devices.

In the device of this invention, an adapter is mounted outboard of the gear reduction box assembly of the landing gear by means of a coupling. The source of motive power is ideally (but is not limited to) obtained by tapping into the existing air brake line on the trailer/chassis unit to utilize the air pressure therein. The pneumatic, hydraulic or electrical drive assembly to power the rotation of the outboard shaft connected to the gear reduction box is then, at will and as needed, attached to the adapter on the outboard shaft. In one embodiment, the use of the gear reduction box assembly's outboard shaft with the adapter as placed on the output shaft of the gear reduction box assembly allows for the changing from high gear, to neutral, and to low gear in a simplified fashion. Built-in spring tension in the coupling maintains the unit in high gear until a change of gear is desired. Low gear can be obtained by a simple manual shifting.

The system of this invention can utilize an air control valve to direct the air pressure from the brake line to a reversible pneumatic, (hydraulic systems are powered externally as well as is an electrically powered system) impact or ratchet assembly to cause either forward or reverse rotation of the gears in the gear reduction box assembly as desired to raise or lower the landing gear legs. The system of this invention can be installed on existing landing gear reduction box assemblies. The device of this invention is also operable even when submersed in water.

Therefore, it is a further object of this invention to provide a system for the mechanical power assisted operation of the rising and lowering of a semi-trailer's landing gear.

It is therefore a still further object of this invention that the system of this invention be retrofitted onto existing trailer landing gear assemblies without impairing the operability of the prior art, manually operated systems already installed on the trailer. Thus, should the system of this invention fail for any reason, the manually operated former system can still be utilized to raise and lower the landing gear.

It is another object that the system of this invention can be installed on existing trailer landing gear systems without the need for rebuilding the entire landing gear system.

The system of this invention incorporates an ability to shift gears facilitating raising and lowering the legs of a trailer with a heavy load. The knob can be affixed to the crank shaft with a quick-release pin to allow changing of the knob back to a hand crank in the event that the user wishes to switch back to hand crank usage.

Also, the use of this device reduces physical injuries due to exertion caused by hand cranking. The use of this device also reduces parking space requirements since no space need be left for a user to hand crank the landing gear. The system of this invention, including its pneumatic impact/ratchet, is water-proof and very rugged, will operate in a very wide range of temperatures and is unaffected by freezing conditions. Further there is no shock or explosion hazard when using the system of this invention as is found in many of the prior art systems. Also, there is only a small number of components in the system of this invention in contrast to the rather complicated mechanical pneumatic actuators of the prior art. Moreover, the system of this invention is fully adapted for almost all existing landing gear systems, is lightweight and compact, and can be installed at a low cost.

### BRIEF DESCRIPTION OF THE DRAWINGS

The above brief description, as well as further objects, features and advantages of the present invention will be more fully appreciated by reference to the following detailed description of the presently preferred but nonetheless illustrative embodiments in accordance with the present invention when taken in conjunction with the accompanying drawings, wherein:

FIG. 1 is a side elevation of the preferred embodiment of the present invention;

FIG. 1A is an end view of the present invention where the powered ratchet is attached;

FIG. 1B is an end view of the present invention illustrating the end of the present invention where it is attached to the outboard shaft of the gear reduction box;

FIG. 2 is a view of the present invention giving perspective to the end of the present invention that is attached to the powered ratchet;

FIG. 3 is a view of the present invention giving perspective to the end of the present invention that attaches to the outboard shaft of the gear reduction box; and

FIG. 4 is a view of a leg of a landing gear assembly with the attendant gear reduction box attached.

FIG. 5 is an example of a pneumatically powered rotational device oriented to the adapter.

FIG. 5A is the adapter as would be oriented to a rotational device.

FIG. 6 is an example of a rotational device engaged with the adapter.

### DETAILED DESCRIPTION OF THE PREFERRED EMBODIMENT

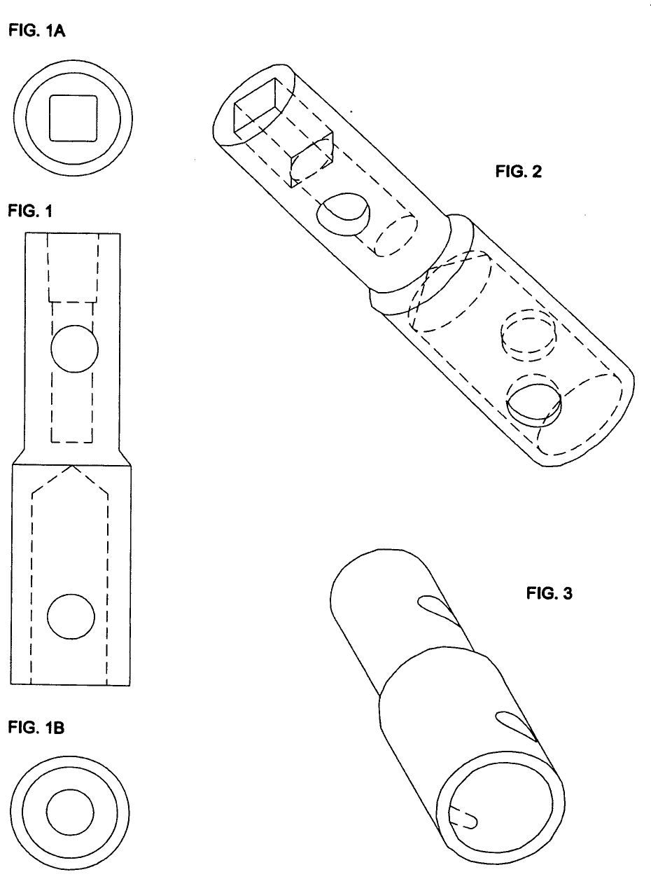

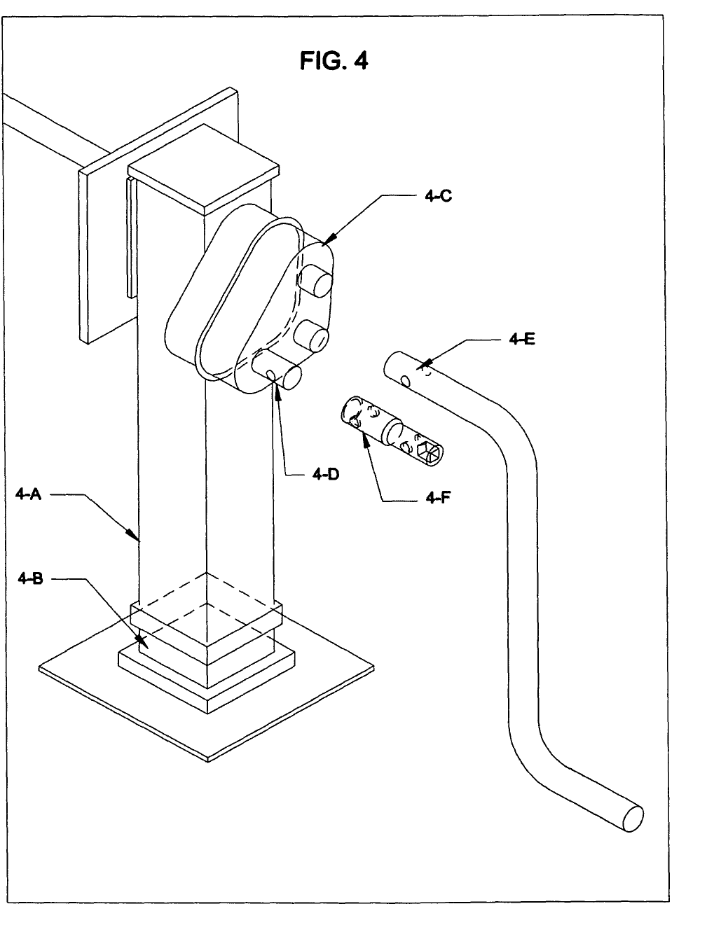

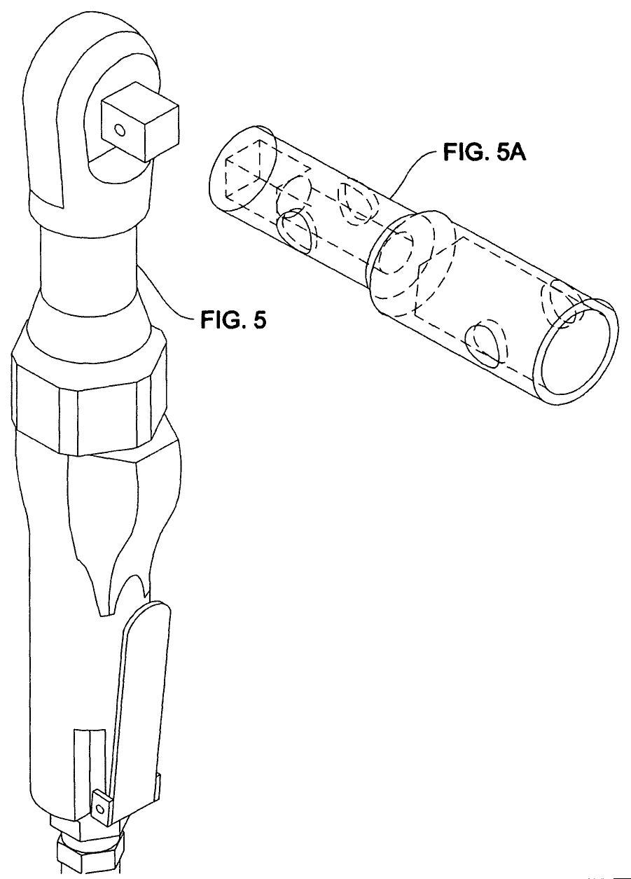

With reference to the figures, like reference characters will be used to indicate like elements throughout the several embodiments and views thereof. In particular, with reference to FIGS. 1, 1A, 1B, 2 and 3, the adapter 100 of the present invention is composed of a first connecting portion 102 and a second connecting portion 104. The first connecting portion 102 is designed to be connectable to the outboard shaft of a gear reduction box assembly or other gear mechanism for raising and lowering the landing gear of a trailer.

The second connecting portion 104 is formed to connect to a powered ratchet or other power tool/device designed to deliver powered, mechanical, hi-torque rotation, including but not limited to air impact tools, ratchet devices, other externally powered rotational devices.

In one embodiment, the adapter 100 is formed from machined carbon steel, ceramic material, or any such material that is of sufficient strength and is of such characteristics that will allow it to be put into the shape of the adapter. In order to accommodate their specific purposes, the first connecting portion 102 may be further formed to accommodate a connection to the outboard shaft of the gear reduction box]. At the same time, the second connecting portion 104 may be further formed to allow the machining of the connection to allow connection to a powered rotational device.

As shown in FIG. 4, present invention is further directed to an adapter 100 that is mounted outboard of the gear reduction box assembly 4C of the landing gear 4A by means of the first connecting portion 102 of the adapter 100 that connects to the outboard shaft 4D of the gear reduction box assembly 4C. The source of motive power is ideally (but is not limited to) obtained by tapping into the existing air brake line on the trailer/chassis unit to utilize the air pressure therein. The pneumatic, hydraulic or electrical drive assembly (not shown) to power the rotation of the outboard shaft 4D connected to the gear reduction box, and thus the lowering or raising of the landing leg jack and pad 4B, is then attached to the second connecting portion 104 of the adapter 100 on the outboard shaft 4D.

In one embodiment, the use of the gear reduction box assembly's outboard shaft 4D with the adapter 100 as placed on the outboard shaft 4D of the gear reduction box assembly 4C allows for the changing from high gear, to neutral, and to low gear in a simplified fashion, via the coupling (not shown) of the gear reduction box assembly 4C. Built-in spring tension in the coupling maintains the unit in high gear until a change of gear is desired. Low gear in the gear reduction box assembly 4C can be obtained by a simple manual shifting as would be known to those of skill in the art.

For illustration purposes, a conventional crank 4E would normally be attached to the outboard shaft 4D of the gear reduction box assembly 4C and operated to extend and retract the landing gear assembly. A perspective view 4F of the adapter 100 is shown for purposes of clarity illustrating the positioning of the present invention with respect to the outboard shaft on the gear reduction box assembly. Again, for clarity purposes, the position of the crank is shown to the present invention such that the present invention is designed to facilitate the reattachment of the crank to the present invention in case the use of the crank is desired or required.

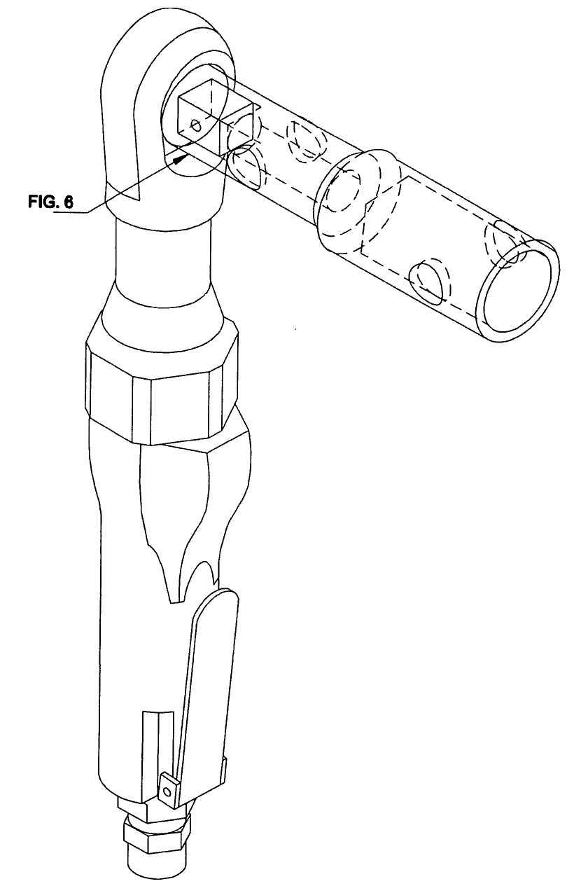

As shown in FIGS. 5, 5A and 6, the system of this invention may also utilize an air control valve 106 to direct the air pressure from the brake line to a reversible pneumatic, (hydraulic systems are powered externally as well as is an electrically powered system) impact or ratchet assembly 108 to cause either forward or reverse rotation of the gears in the gear reduction box assembly as desired to raise or lower the landing gear legs. The air valve 106 on the brake line within the system, also serves as a safety mechanism to prevent the inadvertent raising or lowering of the landing gear. The system of this invention can be installed on existing landing gear reduction box assemblies.

Although the present invention has been fully described in connection with the preferred embodiment thereof with reference to the accompanying drawings, it is to be noted that various changes and modifications will be apparent to those skilled in the art. Such changes and modifications are to be understood as included within the scope of the present invention as defined by the appended claims, unless they depart therefrom.

I claim:

1. An adapter for connecting the gear mechanism of a landing leg of a trailer to a powered rotation-delivering device, the gear mechanism being configured to raise and lower the landing leg of the trailer, comprising:
a first connecting end configured to operatively connect to the gear mechanism; and
a second connecting end configured to operatively connect to an output end of a mechanical rotation delivery device.

2. An adapter according to claim 1, wherein the first connecting end is configured to operatively connect to a gear reduction box assembly of the gear mechanism.

3. An adapter according to claim 1, wherein the second connecting end is configured to operatively connect to an output end of a pneumatic, hydraulic, or electric rotational tool.

4. An adapter according to claim 1, wherein the second connecting end is configured to operatively connect to an output end of a hand crank.
